(19) United States
(12) Patent Application Publication
(10) Pub. No.: US 2005/0020393 A1
(43) Pub. Date: Jan. 27, 2005

(54) Parachute for low altitude deployment

(76) Inventors: Josef Straka, Prague (CZ); Premysl Nosek, Prague (CZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/799,581

(22) Filed: Mar. 12, 2004

Related U.S. Application Data
(60) Provisional application No. 60/455,077, filed on Mar. 13, 2003.

(51) Int. Cl. F16D 1/00

(52) U.S. Cl. 474/145

(57) ABSTRACT

A parachute is adapted for deployment at low altitudes and low air speeds, such as for use in emergency evacuations from buildings. A canopy of the parachute includes a conical portion with a top polar opening. The canopy also includes a porous section that create an airflow stream during descent, generating forward speed and enabling the parachute to be steered during descent. The materials used in the canopy lines and the harness help reduce shocks and help to sustain a substantially steady-state internal air pressure in the canopy. A method for folding the parachute helps to reduce the time to deployment.

### RELATED APPLICATION

This application claims priority pursuant to 35 U.S.C. 119(e) to co-pending U.S. Provisional Patent Application Ser. No. 60/455,077, filed Mar. 13, 2003, which is hereby incorporated by reference in its entirety.

### BACKGROUND OF THE INVENTION

1. Field of the Invention

The present invention generally relates to parachutes. More specifically, the present invention relates to parachutes that are adapted for use in low altitude situations.

2. Description of the Related Art

Most parachutes are unsuitable for low speed deployments, such as those involving jumps at lower altitudes from a fixed object. For instance, most parachutes are not suitable for use during an emergency evacuation from a building. This is especially true when an untrained evacuee is using the parachute for such an emergency evacuation.

Standard parachute canopies do not open fast enough when deployed at low speeds. This is due, in part, to the physics involved in getting the parachute to properly deploy and, in part, to the physical structure of the parachute. The deployment difficulties experienced at low speeds is disadvantageous when parachuting from buildings because the initial speed upon exiting the building is quite low. The canopy only becomes fully open after the evacuee has descended a significant distance to gain sufficient speed. Unfortunately, once sufficient speed has been obtained, standard parachute canopies may not sufficiently slow the evacuee's descent speed within the remainder of the descent such that the likelihood of serious injury or death can be reduced or eliminated.

Also, with standard parachute canopies, a user typically experiences a pulse effect after the canopy opens. The pulses occur when a rapid increase of pressure inside the open canopy causes the canopy to flatten momentarily such that some of the excess pressure can be released. During a pulse, the user may experience a higher than normal deceleration in the rate of descent, which can result in high g-forces being transmitted to the user.

Following the pulse, as the canopy regains its normal shape, the rate of descent momentarily increases, sometimes reaching descent rates that are faster than the final steady-state descent rate. Several pulses may occur during the descent before the canopy reaches a steady-state shape and internal pressure. As can be expected, each pulse can result an undesirable shock to the user.

Furthermore, when the canopy flattens during a pulse, the canopy tends to slip sideways through the air while the user falls generally downward. Even after reaching a steady-state condition, standard parachute canopies tend to behave somewhat like an airfoil in turbulent or windy conditions because of low internal volumes and pressures. Thus, standard parachute canopies can slip sideways through the air during descent. The combination of side slip and downward acceleration of the user can cause the user to swing like a pendulum. The combination also can lead to oscillations, resulting in a similar pendulum effect and reducing the stability of the descent. The canopy creates less aerodynamic drag during these oscillations, which increases the descent rate. In extreme situations, the canopy may even collapse.

Forward speed is important in parachuting as it causes the parachutist to roll upon landing, thereby breaking the fall. In addition, during building evacuations, sufficient forward speed would be desirable to reduce the likelihood that the user or the user's parachute will contact the building being evacuated, which contact can cause injury to the user or can collapse the parachute canopy. Unfortunately, typical parachute canopies generate either too much or not enough forward speed to render them suitable for untrained individuals. Most typical round parachute canopies generate almost no forward speed while most ram air canopies behave like airfoils and generate too much forward speed. Too much forward speed causes the ram air canopies to cover large horizontal distances during a descent unless properly steered. Of course, steering is a skill that must be mastered through practice and, therefore, is undesirable in the design of a device used by untrained users.

Furthermore, typical parachute designs suffer from additional limitations. For instance, most parachutes are designed for and limited to narrow weight ranges. These limitations are undesirable during emergency evacuations as there is limited time for the selection of the proper parachute by the evacuee. Also, parachute harnesses used in conventional parachutes are generally unsuitable for building evacuations for several reasons. For example, conventional parachutes do not adequately account for the need to store and protect the static line in order to reduce or eliminate the likelihood of damage to the static line or of accidental deployment of the canopy when the parachute is being moved. In addition, conventional parachutes generally do not protect the canopy from damage that might be caused by prolonged expose to extreme temperatures, sunlight or wet environments, for example.

The relatively short descent distance and the need for rapid deployment amplify the severity of these shortcomings in the context of a low altitude building evacuation. There is thus a need for a parachute canopy and harness that are specifically designed for low speed deployment at low altitude, such as a building evacuation.

### SUMMARY OF THE INVENTION

Accordingly, one feature, aspect or advantage of certain embodiments of the present invention provides parachutes used in low speed deployment at low altitude, such as emergency evacuations from buildings. In particular, one feature, aspect or advantage of certain embodiments of the present invention provides parachutes that open more rapidly upon departure from a building and that reach a generally steady-state shape and internal pressure more rapidly than conventional parachutes.

Another feature, aspect or advantage of certain embodiments of the present invention provides an improved parachute that provides sufficient forward speed, turning and braking ability during the descent while making the improved parachute more intuitive and user friendly.

Still other feature, aspect or advantage of certain embodiments of the present invention provides an improved parachute that enhances the protection afforded to the integrity of the parachute when the improved parachute is not in use.

One aspect of the present invention involves a parachute comprising a plurality of gores. The gores are secured together to define a canopy. The canopy comprises a top polar opening that is defined by an upper end of the plurality of gore. A plurality of inflation pockets are attached to a lower end of selected ones of the plurality of gores. The inflation pockets are symmetrically positioned about a lower circumference of the canopy. At least one porous section forms a lower portion of at least one of the plurality of gores.

Another aspect of the present invention involves a parachute comprising a canopy. The canopy has a conical upper section. A polar opening is defined by a portion of the conical upper section. A plurality of inflation pockets are positioned about a lower portion of the canopy. A plurality of canopy lines extend downward from the canopy. A harness comprises a first and second riser. The first and second riser are connected to a lower portion of the canopy lines. A connection point is mounted to each of the first and second risers. The connection points are adapted to carry a cargo bag or to connect to rescue lines for lifting or lowering the harness.

A further aspect of the present invention involves a method of folding a parachute canopy. The method comprises forming a wedge shape by folding each gore of the canopy in half such that canopy lines are arranged together. Dividing the resulting wedge shape along its shortest sides into thirds. Folding the thirds into an S shape.

### BRIEF DESCRIPTION OF THE DRAWINGS

These and other features, aspects and advantages of the present invention will now be described with reference to the drawings of certain preferred embodiments, which embodiments are intended to illustrate and not to limit the invention.

FIG. 1 is a top plan view of an open parachute canopy with FIGS. 1a through 1d being various sections through the canopy.

FIG. 2 is a bottom plan view of the open parachute canopy of FIG. 1.

FIG. 3 is a simplified sectioned view of the canopy of FIG. 1 after folding.

FIG. 4 is a view of a storage bag for use with the parachute.

FIG. 5 is a schematic drawing showing the canopy attached to a harness.

FIG. 6 is a view of another harness similar to that shown in FIG. 5.

FIG. 7 is a schematic view of the harness of FIG. 5 with a container attached.

FIG. 8 is a schematic view of the fully folded canopy and the deployment bag.

FIG. 9 is a rear view of the container used with the harness.

FIG. 10 is vector diagram showing forces exerted on the canopy and the canopy lines during descent.

FIG. 11 is a series of diagrams showing the inflation of the canopy.

FIG. 12 is a diagram of the air flow from the canopy.

### DETAILED DESCRIPTION OF THE PREFERRED EMBODIMENT

With reference to the figures, certain embodiments of the present invention will be described, which embodiments provide parachutes that are particularly adapted for use in low speed deployments at low altitudes, such as emergency evacuations from buildings.

One particularly preferred parachute features, among other components, a conical canopy that results in a greater internal volume and pressure as compared to many conventional parachute canopies. The greater internal volume and pressure of the conical canopy greatly reduces the pulse effect upon opening of the canopy, which helps stabilize the parachute during descent. A top polar opening in the canopy also helps stabilize the descent of the parachute, by allowing some of the air in the canopy to escape, thereby reducing the amount of air spilling out from the perimeter of the canopy. Two porous sections in the rear of the canopy create two airflow streams during descent, generating forward speed and enabling the parachute to be steered during descent.

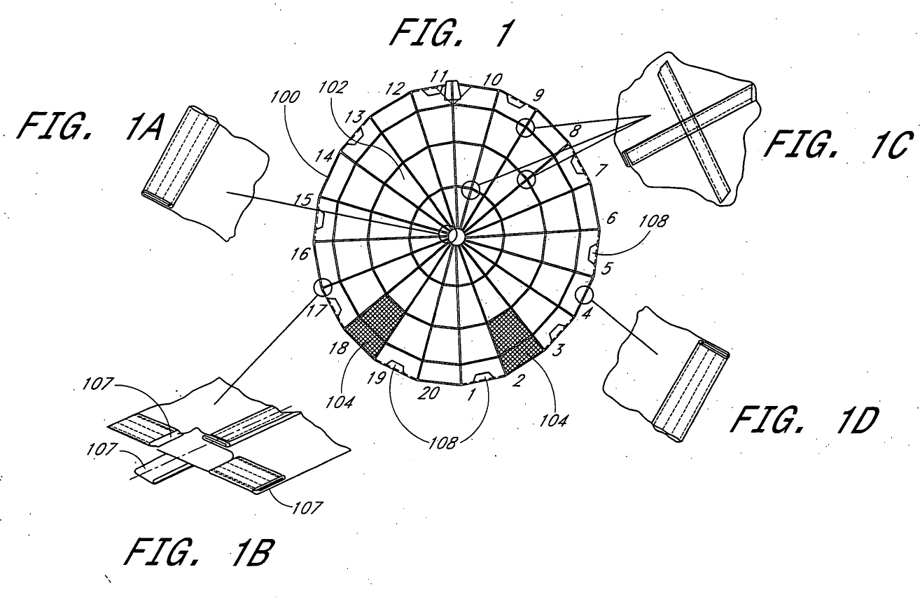

With reference initially to FIG. 1, a parachute canopy 100 is shown in a fully open orientation, which canopy 100 is arranged and configured in accordance with certain embodiments that employ certain features, aspects and advantages of the present invention. The canopy is shown in top plan view.

The canopy preferably is formed of a number of gores 102. In the illustrated arrangement, the canopy 100 comprises twenty gores 102, which are labeled 1 to 20 in FIG. 1. As used herein, the gore 102 is a generally triangularly shaped section of the canopy 100. Each of the illustrated gores 102 is constructed from four segments of low porosity ripstop fabric or another suitable material. In one preferred arrangement, the canopy is made of a type SO 81 fabric made by a French manufacturer named NCV Industries. In another preferred arrangement, the canopy is made of a type SO 82 fabric made by the same manufacturer. In a further arrangement, a low porosity ripstop nylon fabric, such as that made and sold under the name F111/Exacta Chute from Performance Textiles, Inc. can be used.

The illustrated gores 102 advantageously are arranged in a trapezoidal construction. The trapezoidal construction preferable is approximately 385 cm (height) by 96 cm (bottom length) by 6 cm (top length). These dimensions relate to each other in a proportion of about 64.167 to 16 to 1. Other scaled dimensions of this preferred trapezoidal construction can be used to form larger or smaller canopies 100. This trapezoidal shape has been found to result in a preferred substantially steady-state canopy shape. Furthermore, when the trapezoidal segments are secured together, the resulting conical canopy 100 includes a top polar opening 106. As will be discussed, the polar opening 106 vents some of the pressure by allowing air to pass from within the canopy 100 through the uppermost portion of the canopy 100.

At least two segments of at least two gores 102 preferably are made of a porous material that allows substantial air to flow through the segments. In the illustrated arrangement, two outer segments 104 of gores 102, which gores are numbered as 2 and 18, are formed of nylon netting or “monofil.” These two porous areas 104 are represented by gray shading in FIG. 1. As discussed in further detail below, airflow through these two porous areas 104 allows the canopy 100 to generate forward airspeed and enables steering air flow for the parachute.

In one embodiment, each of the segments of the canopy 100 is sewn to the adjacent segments using lock/fold seams, for example. These seams can be reinforced with a reinforcing member 107, such as nylon support tape or the like, as illustrated in the enlarged partial sectional views of FIG. 1 (see FIGS. 1a-1d). The reinforcing member 107 preferably is at least partially wrapped inside of an edge portion of the respective segments prior to the seams being formed. With reference to FIG. 1b, the reinforcing member 107 at the outer or bottom edge at each intersection between two adjacent gores 102 can be doubled over and sewn in place to form loops that accommodate canopy line attachments, which will be discussed below.

In one embodiment, a trapezoidal inflation pocket 108, measuring about 15 cm (height) by 37 cm (top length) by 57 cm (bottom length), is sewn on the exterior of the bottom edge of alternating gores (odd numbered gores in the illustrated arrangement). The inflation pockets 108 may also be made of ripstop fabric or another suitable material. Each inflation pocket 108 preferably is sewn onto the canopy 100. Slack preferably is provided between the inflation pocket 108 and the respective gore 102 such that the inflation pocket 108 and the gore 102 can capture air in the space between them, which increases the speed with which the canopy 100 can be opened. Thus, in some embodiments, the inflation pockets 108 can help increase the speed of deployment of the canopy.

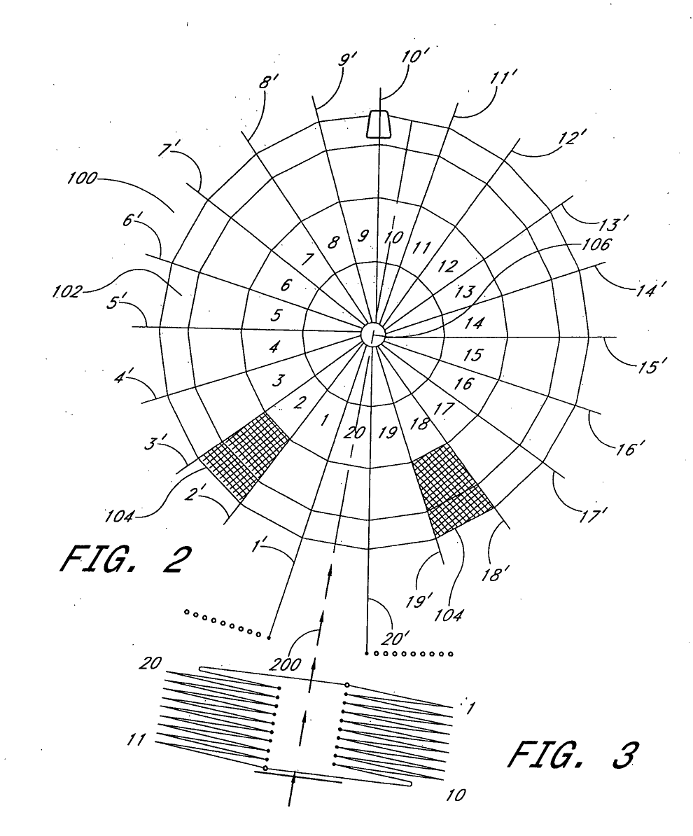

With reference now to FIG. 2, canopy lines, labeled 1′ to 20′, are attached to the canopy. Preferably, the canopy lines are attached to the loops formed at the seams between each pair of adjacent gores 102. In the illustrated arrangement, the canopy lines are attached at the outer or bottom edge of the canopy 100.

With reference to FIG. 2, a dashed line 200, which bisects gores 10 and 20 in the illustrated embodiment, shows the preferred direction of flight of the canopy 100 during descent. Gore 10 is thus at the front of the canopy 100, while gore 20 is at the rear. Steering lines can be optionally attached to the canopy lines that border the porous areas 104. In one embodiment, aq right steering line can be attached to canopy line 3′, and a left steering line can be attached to canopy line 18′. During descent, the user can pull on the steering lines, which in turn pull on the attached canopy line. Pulling on either steering line reduces the profile of the corresponding porous area 104, thereby reducing the rate of escaping airflow and reducing the forward thrust created at that porous area 104. Thus, pulling on one steering line allows the user to direct the descent towards the opposite side of the canopy. Furthermore, pulling on both steering lines allows the user to reduce the forward speed of the descent.

At the top end of the canopy 100, one end of an umbilical line 110 is attached to the top polar opening 106. The attachments are preferably made via weak-link nylon break cord, with tensile strength of approximately 50-80 lbs, so that the umbilical line 110 detaches from the top polar opening 106 upon deployment of the canopy 100. The other end of the umbilical line 110 is attached to a deployment bag 180, shown in FIG. 8. The deployment bag 180, which is discussed below, contains the canopy 100 until the parachute is used. After deployment of the canopy 100, the umbilical line 110 is designed to break, separating the deployment bag from the canopy 100. A static line (not shown) of the parachute can be attached to a bottom surface of the unfolded deployment bag 180, if desired.

A choker band 182 closes the top polar opening 106 of the canopy 100 closed until after deployment. Preferably, the choker band 182 closes the opening 106 until almost full deployment of the canopy 100 has occurred. In certain instances, the canopy 100 may be considered to be fully open after its internal volume has reached between about 70% and about 100% of its equilibrium internal volume. The choker band 182 may be made of an elastic material. In some embodiments, the top polar opening 106 can be closed by weak tensile strength stitching. The properties of the choker band 182 or the like can be adjusted to advance or delay the timing of the opening of the top polar opening 106.

The illustrated canopy preferably is sized for a universal fit so that the user does not have to select a parachute with a properly-sized canopy while under the stress of an emergency evacuation. The formula Gmax=0.5×Ro×v²×S×Cr may be used to determine the size of the canopy, where Gmax is the maximum supported mass of the parachute with the user as well as any cargo, Ro is the standard atmospheric air pressure, v is the speed of descent, S is the surface area of the canopy, and Cr is the canopy resistance factor. The parachute is about 7 kgs. In this particular embodiment, the maximum supported mass of the user and the cargo is desirably about 150 kgs, or about 330 lbs. The sum of these two masses then results in a Gmax of about 1540N. Ro is about 1.2257 kg/m². v is about 7 m/s, which has been determined to be a descent speed below which the probability of serious injury or death is relatively low. Cr is about 1.35, which is a constant for the material used. Solving this equation results in a canopy surface area of approximately 38 m². To add a margin of safety, the canopy size in this particular embodiment was enlarged to approximately 40 m². In some embodiments, other formulas or other sizing parameters may be used.

With reference to FIG. 5, the canopy 100 is shown attached to a harness 150. A container 164 of the harness 150 is shown in an open position in this figure. The surface of container 164 is preferably made of water, sweat and heat resistant material to protect its contents, including the canopy. The container 164 is attached to the harness 150 in any suitable manner and can be integrated into the harness so as to form an integrated unit, if desired.

The harness 150 comprises a right riser 152 and a left riser 154. The risers 152, 154 extend upward and provide attachment locations for the canopy 100. In the illustrated arrangement, as shown in FIG. 2 and FIG. 5, canopy lines 1′ to 10′ are attached to the right riser 152 of the harness 150, and canopy lines 11′ to 20′ are attached to the left riser 154 of the harness 154.

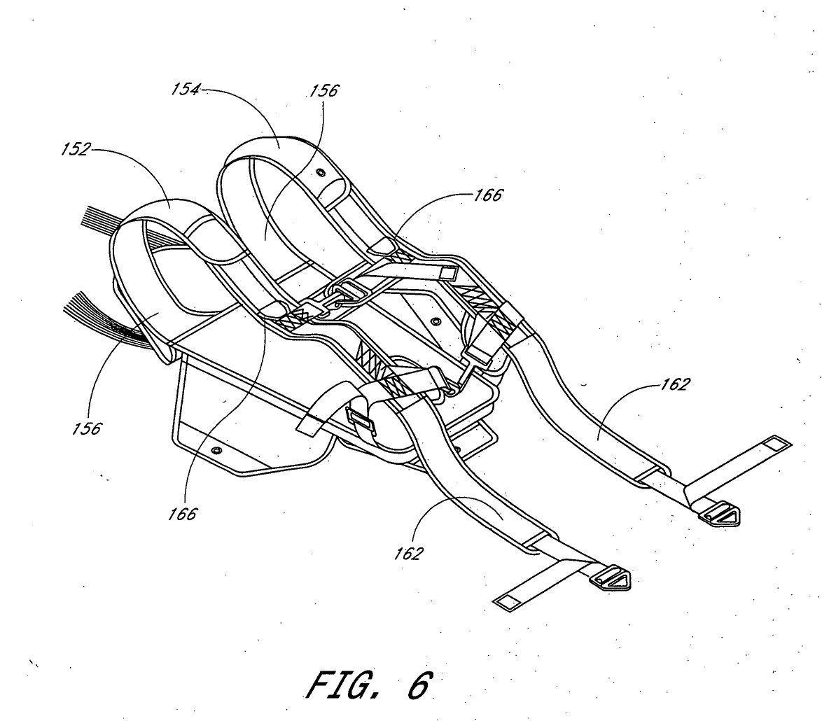

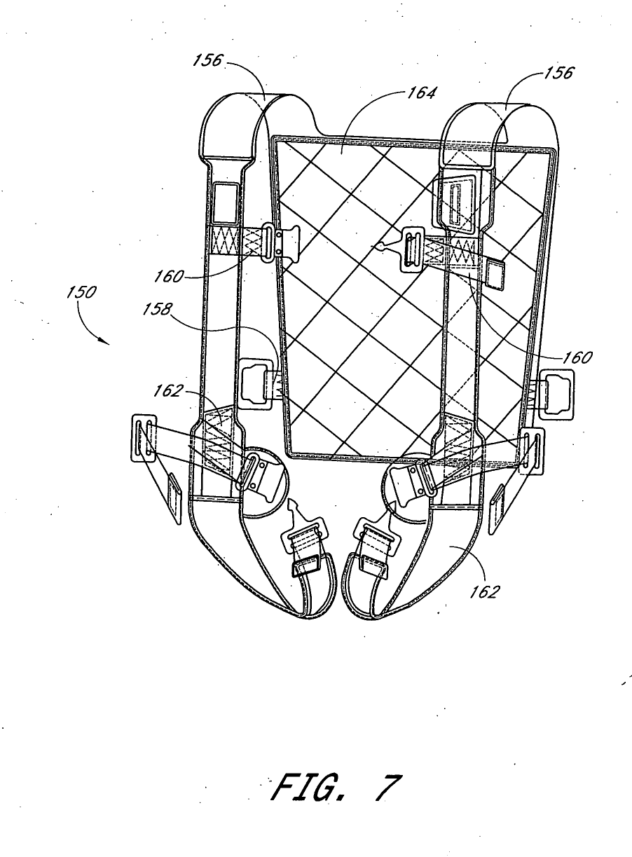

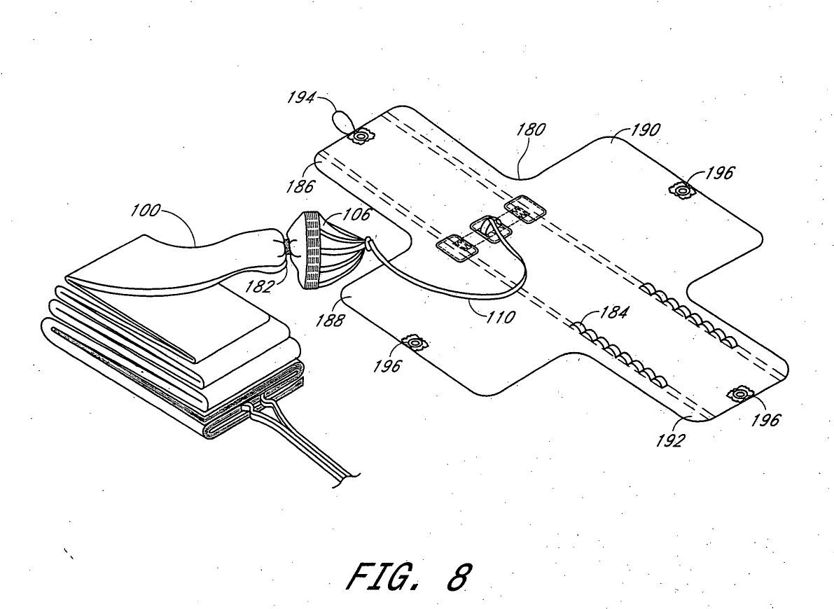

With reference to FIG. 6, the harness is shown in an isometric view. The risers 152 and 154 (shown in FIG. 5) of the harness 150 are each attached to a rear portion of a respective shoulder strap 156. As schematically shown in FIG. 5, in a back portion of the harness 150, the shoulder straps 156 extend downwards and cross at a location above a lumbar strap 158. A lower portion of the shoulder straps preferably are attached to the lumbar strap 158. In the illustrated embodiment, the risers 152, 154 and the shoulder straps 156 form a suspenders-like structure, while the lumbar strap 158 is like the back half of a belt.

An adjustable, releasable chest strap 160 connects the shoulder straps 156 across a chest region of a user. The chest strap 160 preferably is formed of two segments that can be secured together in any suitable manner. More preferably, the chest strap 160 is adjustable to accommodate different sizes of users.

In the illustrated arrangement, two leg straps 162 extend downwards from the risers 152 and 154. The leg straps 162 are sized and configured to wrap around the individual legs of the user. The free end of the leg straps 162 can be secured to the harness in any suitable manner and at any suitable location. In the illustrated arrangement, the leg straps are secured to the ends of the lumbar strap 158, which are provided with suitable clips.

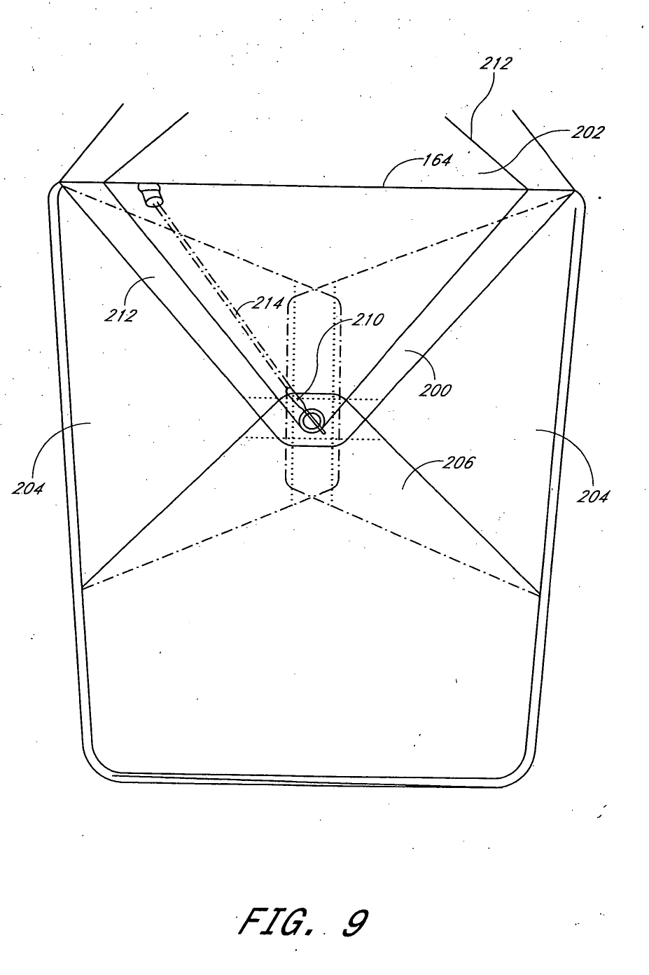

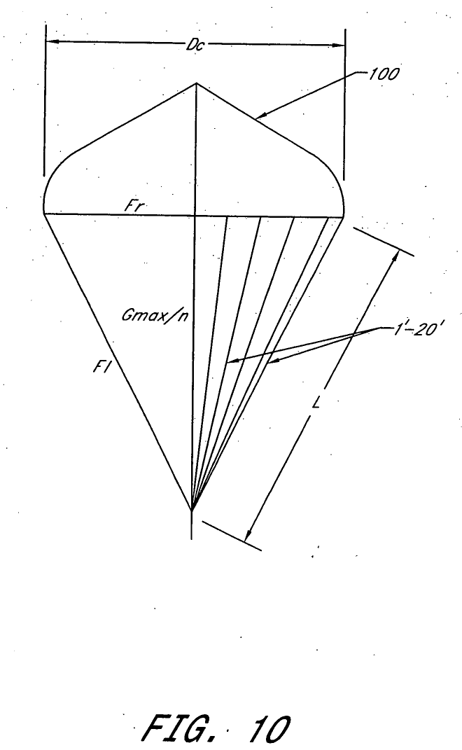

With reference to FIG. 9, the container 164 is shown in a closed position, with the exception of an outer top flap 202, which is open. The inner top flap 200, the side flaps 204 and the bottom flap 206 are folded together to contain the deployment bag. These flaps 200, 204, 206 are secured in a closed position with a release pin 210 or the like. The release pin 210 preferably is attached to a static line 214 at a distance a short length away from the point of attachment of the static line 214 to the deployment bag 180. The remaining length of the static line 214 preferably is stored in a pouch that can be defined by hook and loop fasteners 212, or the like, that run along the edges of the inner top flap 200 and outer top flap 202. Other closure mechanisms, including interlocking components that separate rather easily, also can be used.

The other end of the static line 214 is routed through a similar pouch in one of the shoulder straps 156, such as the right shoulder strap 156 in the illustrated embodiment. The static line 214 can be attached to a static line securing device (not shown), such as a ring, caribeener or other suitable hooking device, that is positioned along the shoulder strap 156. The ring can be removed from the shoulder strap 156 and can be secured to a suitable location in the building before jumping from the building or other structure. In some embodiments, a static extension line may be provided to allow the user to connect the static line to an anchor further towards the interior of the building or further from the jump point on the structure. The static extension line may also be used to assist the evacuee in climbing, as well as lowering or hoisting a person.

As discussed above, the harness is adjustable to fit evacuees of different body shapes and sizes. In some other embodiments, the harnesses 150 can be sized for a range of body shapes and sizes. Parachutes having such a construction preferably are clearly marked with sizes, both on the harness itself and on their storage bags. An exemplary storage bag 163 is shown in FIG. 4. The storage bag 163 preferably is made of an ultraviolet light, water and/or heat resistant material to protect the parachute. Any suitable storage bag 163 can be used.

As shown in FIG. 6, the harness 150 can be provided with connection points 166 to which an optional cargo bag can be attached. In the illustrated arrangement, the connection points 166 are formed by D-rings or other suitable mechanical members. The connection points 166 also can be used for hoisting or lowering a user without employing the parachute. For instance, the connection points 166 can be secured to lines lowered from a rescue helicopter and the helicopter can carry the user to safety. In one preferred arrangement, the connection points 166 and the assembly of the connection points to the harness 150 enable loads of approximately 800 lbs to be lifted.

The optional cargo bag may be attached to the connection points 166 or elsewhere on the harness 150, to carry cargo, infants or pets during an evacuation. The cargo bag preferably contains air vents or the like to help control movement of the cargo bag during descent. The cargo bag can be used to carry various items, including, but not limited to, small animals, important documents, personal belongings and the like.

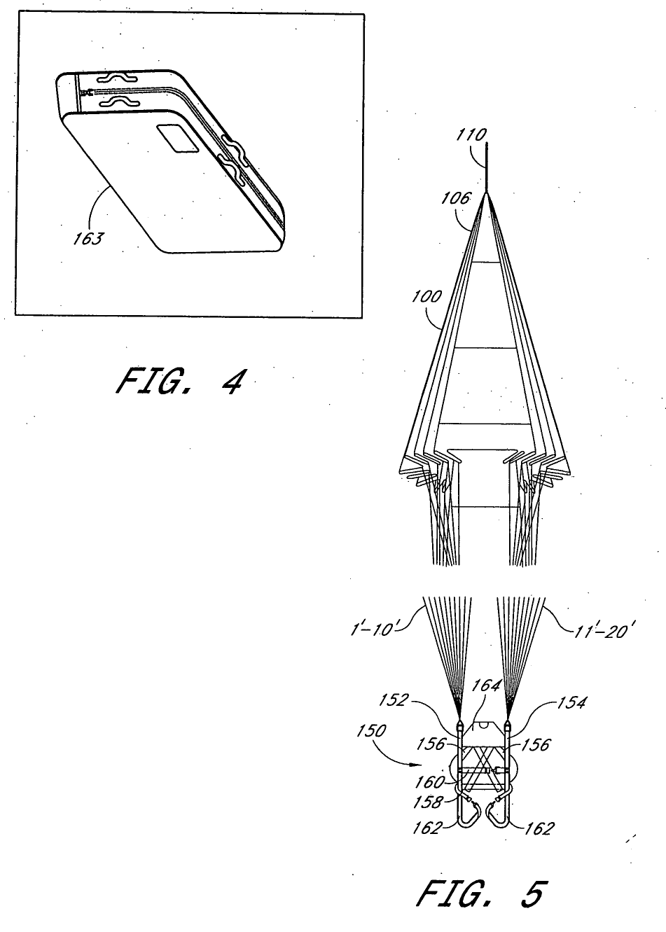

With reference initially to FIG. 2, the canopy preferably is folded in a manner that helps preserve the integrity of the canopy during storage and facilitates rapid deployment of the canopy during use. Preferably, folding of the canopy is performed in a symmetrical fashion. For instance, gores 20 and 19 are first each folded in half to bring canopy lines 1′ and 19′ adjacent to one another, with canopy line 19′ being above canopy line 20′. In other words, the centers of the gores are lifted which brings the outer edges of each gore together. Gores 1 and 18 are then each folded in half to bring canopy lines 2′ and 18′ adjacent to one another with canopy line 2′ being above canopy line 1′ and canopy line 18′ being above canopy line 19′, which is already on top of canopy line 20′. This folding pattern is repeated with gores 2 and 17, and so forth, resulting in the double fan wedge shape shown in FIG. 3. The double fan wedge shape is then folded into an “S”, by dividing the wedge into thirds and folding the left third over the middle third and the right third underneath the middle third. This folding method helps achieve consistent deployment of the canopy in a desired orientation relative to the user. In addition, this style of folding places the canopy lines in the center, with the folded canopy gores 102 arranged around the canopy lines. The perimeter of the canopy 100 is thus arranged in a particular orientation to catch air after its release from the deployment bag 164. Together with the evenly distributed inflation pockets 108, the folding technique fosters even opening of the canopy 100 during deployment.

The folded canopy 100 is placed in the deployment bag 180, and the canopy lines are folded into S loops and tucked into elastic bands 184. The elastic bands 184 hold the length of the canopy lines along one flap 192 of the deployment bag 180. The flaps 186, 188, 190 and 192 are then folded inwards to contain the canopy 100 and the canopy lines.

A loop 194 is attached to a top flap 186 of the canopy bag. The loop 194 is sized and configured to be passed through the holes 196 of the other flaps 188, 190 and 192. Any length of the canopy lines remaining outside the deployment bag 180 can be folded and slipped through the loop 194 to secure the deployment bag 180 in a closed position.

As discussed above in connection with FIG. 5, the lower end of the canopy lines preferably are attached to the harness 150 at the risers 152, 154. The deployment bag 180 can be placed in the container 164 of the harness 150 for storage purposes.

After the user jumps using the illustrated parachute, the static line 214 is pulled out of the right shoulder strap velcro compartment and the pouch formed by the inner and outer top flaps 200 and 202. The static line 214 also pulls out the release pin 210 and opens the container 164. The static line 214 continues to pull the deployment bag 180 out of the container. Referring again to FIG. 8, the folded portion of the canopy lines external to the deployment bag 180 is pulled from the loop 194 of the deployment bag 180, which allows the deployment bag 180 to open. After the canopy 100 deploys, the umbilical line 110 breaks and the deployment bag 180 is separated from the canopy 100. The deployment bag 180 and the static line 214 are designed to remain attached to the building.

With reference to FIG. 10, forces are applied to the canopy 100 and the canopy lines. In one arrangement, the formula Fl=(Gmax/n)/sqrt(1−(DC/2L)²) may be used to illustrate a relationship between the force on a canopy line Fl and its length L, where Gmax, as above, is the maximum supported mass of the parachute with the user as well as any cargo, n is the number of canopy lines, and Dc is the diameter of the canopy. The relationship between the force on a canopy line and its length has been found to be inversely proportional. Thus increasing the length of the canopy line reduces the force exerted on it, which also contributes to a lessening of the shock caused by the opening of the canopy. However, longer canopy lines also translate into longer canopy opening and deployment time, as well as additional weight. Conversely, if the canopy lines are too short, the canopy may not open fully under the load of the user and/or cargo, thus reducing the stability of the canopy. An ideal canopy line length minimizes the opening time, while allowing the canopy to fully open and maintain stability during descent over the entire supported mass range, which is up to approximately 150 kgs in the presently preferred embodiment. Testing under a variety of conditions has revealed that a particularly desirable canopy line length to be approximately 5.65 m. Once again, both the example formula and the values therein may be adjusted by those of skill in the art to determine an optimal length or range of lengths for the canopy lines.

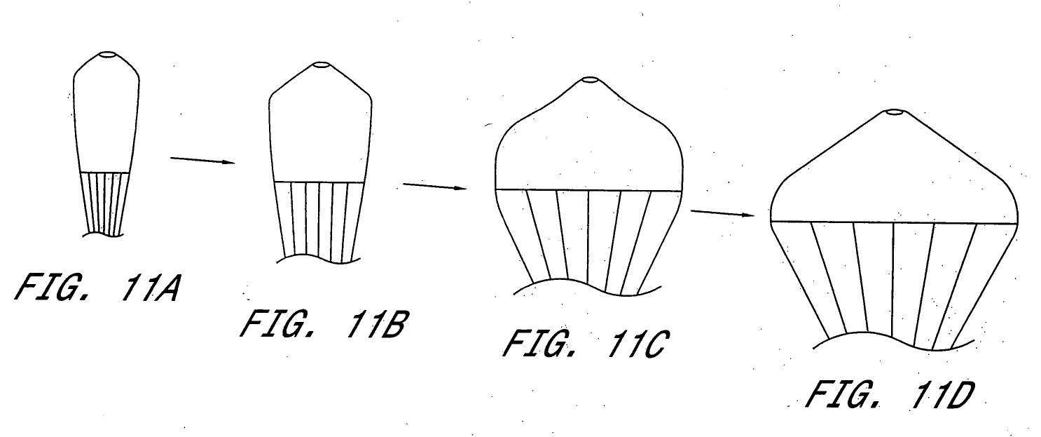

The canopy 100 also minimizes the pulse effect. As the canopy 100 opens, its conical shape increases drag more gradually compared to other canopies, by maintaining a tubular or balloon like shape. See FIGS. 11a-d. The greater internal volume of the canopy 100 also resists the flattening experienced by other canopies to vent excessive internal pressure. Also, the canopy lines have a certain degree of elasticity that absorbs the shock caused by the opening of the canopy 100. In certain preferred embodiments, the canopy lines are able to increase in length by at least about 30% and preferably about 40% before the material of the canopy lines yields. The elasticity helps to decrease pulsing of the parachute during descent. In one particularly preferred arrangement, the parachute has a full system elasticity of about 20% built into the parachute system to reduce the level of pulsing experienced during use.

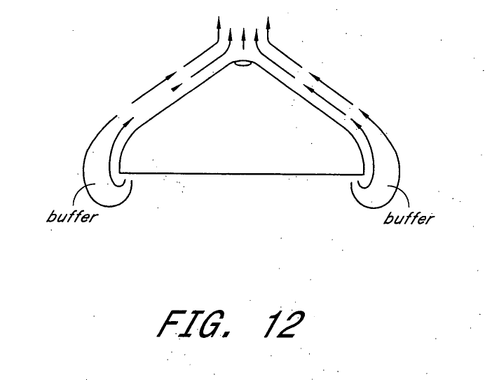

The descent of the described parachute is also more stable than other parachutes. The conical shape and greater internal volume of the canopy 100 make it less susceptible to wind current and turbulence. As discussed above, flatter canopies have a greater tendency to slip sideways through the air, leading to a pendulum-like descent. The conical shape of the canopy 100 also allows air spilling from underneath its perimeter to maintain a more attached or laminar flow along the top of the canopy, which merges with the air flowing out of the top polar opening 106. See FIG. 12. This air flow creates a buffer that helps avoid collisions and that improves the stability of the canopy 100 during descent. The perimeter of the canopy 100 may be tapered inwards towards its bottom edge to modulate this buffer.

The stability is further enhanced by the porous areas 104 in gores 2 and 18. The air flow out of these two porous areas 104 from the interior of the canopy 100 gives the parachute forward motion. The illustrated arrangement advantageously provides a forward movement and facilitates steering of the canopy during descent. Thus, the illustrated arrangement can greatly reduce the likelihood of drifting and the parachute can be directed toward a landing point, if desired. As discussed above, forward motion is desirable because it causes the user to roll upon landing, which helps lessen the impact upon landing.

In two jumps made to test the function of a preferred embodiment, jumps were made from 95 meters with a parachute weight of 7 kg and parachute loads of 54 kg and 86 kg, respectively. The testing environment featured about 75% humidity, variable winds of about 3-4 m/s, barometric pressure of about 1013 hPa and a temperature of about 16 degrees C. The length of the deployment lines was about 6.2 m. The canopy filled in about 2.65 seconds and about 3 second respectively with the total jump time being about 13 seconds and about 10 seconds, respectively, to landing. The user descended at an angle of about 15 degrees on both jumps and had a rate of descent of about 4.5 m/s and about 5.5 m/s, respectively.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

1. A parachute comprising a plurality of gores, the gores being secured together to define a canopy, the canopy comprising a top polar opening that is defined by an upper end of the plurality of gore, a plurality of inflation pockets being attached to a lower end of selected ones of the plurality of gores, the inflation pockets being symmetrically positioned about a lower circumference of the canopy, and at least one porous section forming a lower portion of at least one of the plurality of gores.

2. The parachute of claim 1, wherein the plurality of gores consists of 20 gores.

3. The parachute of claim 2, wherein each of the gores has a generally trapezoidal shape.

4. The parachute of claim 3, wherein the generally trapezoidal shape has sides that are about 64.167 to about 16 to about 1 in proportion.

5. The parachute of claim 4, wherein the generally trapezoidal shape is approximately 385 cm by approximately 96 cm by approximately 6 cm.

6. The parachute of claim 1, wherein the canopy has an even number of gores and the inflation pockets are positioned on alternating gores.

7. The parachute of claim 1, wherein the top polar opening is substantially closed by a choker band prior to use.

8. The parachute of claim 1, wherein the at least one porous section comprises two non-adjacent porous sections.

9. The parachute of claim 8, wherein the two porous sections are adapted to effectuate steering.

10. A parachute comprising a canopy, the canopy having a conical upper section, a polar opening being defined by a portion of the conical upper section, a plurality of inflation pockets being positioned about a lower portion of the canopy, a plurality of canopy lines extending downward from the canopy, a harness comprising a first and second risers, the first and second riser being connected to a lower portion of the canopy lines, a connection point being mounted to each of the first and second riser, and the connection points being adapted to carry a cargo bag or to connect to rescue lines for lifting or lowering the harness.

11. The parachute of claim 10, wherein the polar opening is secured by a removable choker band prior to use of the parachute.

12. The parachute of claim 10, wherein the canopy further comprises two non-adjacent porous sections.

13. The parachute of claim 12, wherein the two porous sections are adapted to effectuate steering.

14. The parachute of claim 10, wherein the harness further comprises a first compartment for storing a static line.

15. The parachute of claim 14, wherein the harness further comprises at least one shoulder strap, whereby the shoulder strap form at least part of the first compartment.

16. The parachute of claim 15, wherein the harness further comprises a second compartment for storing an extension line for the static line.

17. The parachute of claim 10, further comprising a cargo bag attachable to the harness.
